(19) United States
(12) Patent Application Publication
(10) Pub. No.: US 2003/0208779 A1
(43) Pub. Date: Nov. 6, 2003

(54) System and method for transmitting digital video over an optical fiber

(76) Inventors: Samuel I. Green, St. Louis, MO (US); Donald F. Wilkins, Godfrey, IL (US)

Correspondence Address: HARNESS, DICKEY & PIERCE, P.L.C., P.O. BOX 828, BLOOMFIELD HILLS, MI, 48303, US

(21) Appl. No.: 10/122,532

(22) Filed: Apr. 15, 2002

(51) Int. Cl. H04N 7/16; H04J 3/04

(52) U.S. Cl. 725/143; 370/535

(57) ABSTRACT

A system transmits Digital Video Interface (DVI) signals over a single optical fiber between a video graphics-generating source and a video display device. The system accepts input signals from a conventional DVI transmitter for transmitting video-encoded digital signals to a coarse wavelength division multiplexed (CWDM) optical transmitter. The CWDM optical transmitter produces an optical signal comprised of a multiplexed plurality of optical signals having different wavelengths and outputs this multiplexed optical signal to a single optical fiber. The signal is transmitted over the single optical fiber to a CWDM optical receiver which demultiplexes the signals into a parallel plurality of video encoded optical signals which are each separately received in a corresponding plurality of optical receivers to reproduce the original electrical signals of the DVI transmitter. A conventional DVI receiver converts the encoded video signals into decoded digital video signals that are output to a display device such as an aircraft cockpit display system. The invention permits the transmission of digital video signals over a single optical fiber over greater distances than would otherwise be possible with conventional DVI systems employing copper conductors to conduct electrical signals between the DVI transmitter and the DVI receiver.

### FIELD OF THE INVENTION

This invention relates to systems for transmitting video information to a display device, and more particularly to a system for transmitting multiplexed optical video signals from a video generating source over an optical fiber to a display device.

### BACKGROUND OF THE INVENTION

Transmission of high-speed video from avionic video generators to cockpit displays has heretofore been difficult and costly to implement. One potential solution is the adoption of a commercial-off-the-shelf (COTS) approach. Such an approach would likely save money and improve performance. One such commercial-off-the-shelf approach would be the use of a Digital Video Interface (DVI). Digital Video Interfaces are well known at the present time. They make use of copper conductors that link a DVI transmitter with a DVI receiver and use standardized connectors. However, conventional DVI systems are limited to relatively short link distances typically no greater than about five meters. This distance can be extended to approximately ten meters if the gauge (and the cost and weight) of the copper cables is increased. In aerospace applications, however, it is often necessary to transmit digital video signals over a distance longer than what a standard digital video interface allows. This is especially true on commercial aircraft where digital video signals may need to be transmitted over distances of up to 30 meters or more.

In view of the foregoing, there exists a need for some form of video interface which allows digital video signals to be transmitted over distances greater than that allowed by conventional DVI systems without incurring significant additional costs in the way of additional electronics components. There is further a need to provide such an interface which does not require the use of large or very costly electronic components which require significant additional space and power requirements, and which would therefore make such an interface unsuitable for use in commercial or military aircraft or other forms of mobile platforms. Still further, there is a need for such a digital video interface system which can be used with well known and standardized DVI video generators and DVI connectors.

### SUMMARY OF THE INVENTION

The above and other objects are provided by a digital video interface system in accordance with preferred embodiments of the present invention. In one preferred form, the digital video interface system comprises a standard Digital Video Interface (DVI) transmitter, a standard DVI receiver, a multi-wavelength multiplexed optical transmitter, a single optical fiber, and a multi-wavelength demultiplexed optical receiver. The single optical fiber is coupled between the output of the multi-wavelength multiplexed optical transmitter and an input of the multi-wavelength demultiplexed optical receiver. The multi-wavelength multiplexed optical transmitter receives a parallel plurality of digital video signals from the DVI transmitter. The DVI receiver receives demultiplexed electrical signals from the multi-wavelength demultiplexed optical receiver.

In operation, digital video signals are produced by a video graphics generating source and output to the input of the DVI transmitter. The DVI transmitter encodes the video signals and outputs same as a plurality of encoded digital video signals to the input of the multi-wavelength multiplexed optical transmitter. The multi-wavelength multiplexed optical transmitter produces a corresponding plurality of optical signals of different wavelengths which are simultaneously transmitted from its output over the optical fiber. Within the multi-wavelength demultiplexed optical receiver, these signals are input to the demultiplexer and are separated into a parallel plurality of video encoded optical signals. The video encoded optical signals are subsequently individually received by a plurality of optical receivers which output a plurality of video encoded electrical signals. In one preferred embodiment, the multi-wavelength multiplexer and plurality of optical transmitters, and the demultiplexer and plurality of optical receivers, comprise coarse wavelength division multiplexing (CWDM) transceivers. The video encoded electrical signals are then decoded by the DVI receiver. The output of the DVI receiver is then transmitted to a display device.

Communication over an optical fiber offers greatly extended link distance, much lower cable size and weight, and virtually eliminates problems with electromagnetic interference. The conventional solution of previously developed systems is to send the plurality of DVI signals to an equal number of optical transmitters, over an equal number of optical fibers, to an equal number of optical receivers that regenerate the plurality of DVI signals at the input of a DVI receiver. This method requires at least four and perhaps seven optical fibers, resulting in a multi-fiber interface.

The system of the present invention is ideally suited for use in aircraft and other mobile platforms that require extended link distance and cannot tolerate the weight of heavy cabling. The system of the present invention advantageously allows digital video signals to be transmitted over a single optical fiber over distances of up to 100 meters, or possibly even greater distances, which would not be possible with conventional DVI systems which use copper conductors to transmit electrical signals thereover. Since the present system employs a single optical fiber as the transmitting medium, the plurality of video signals are further much less susceptible to differential phase delay because they all pass through a common medium (i.e., the single optical fiber).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram of a digital video interface system in accordance with a preferred embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

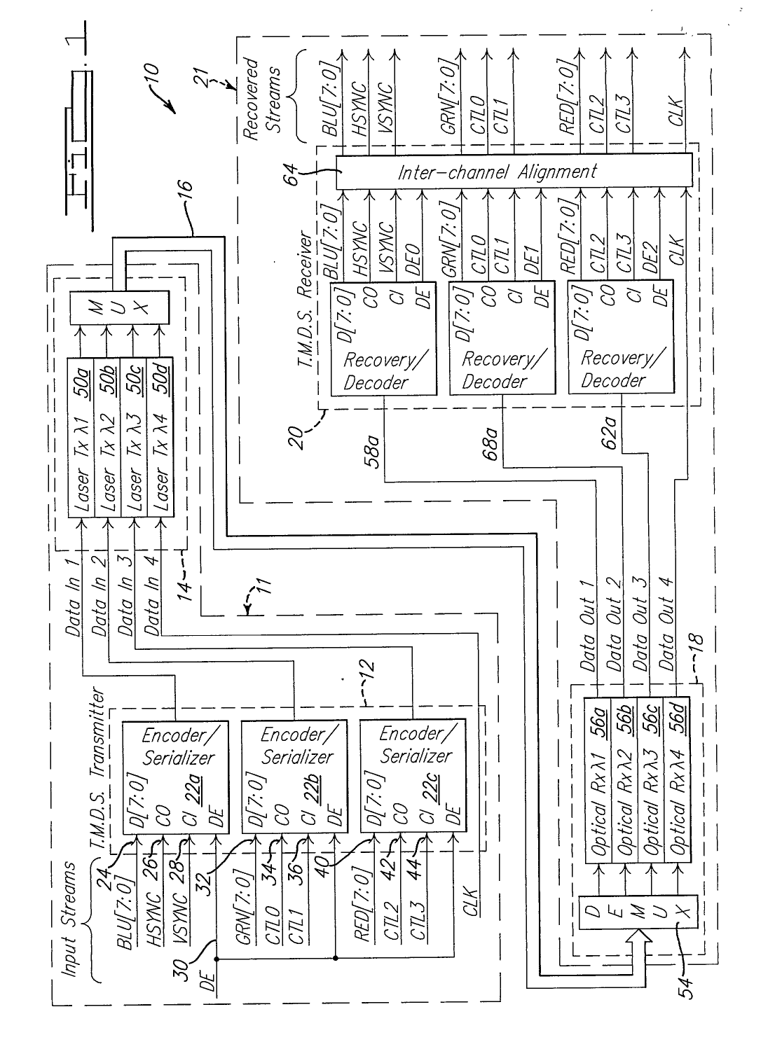

Referring to FIG. 1, there is shown a digital video interface system 10 in accordance with a preferred embodiment of the present invention. The system 10 generally includes a well-known digital video interface (DVI) transmitter 12, a well-known multi-wavelength multiplexed optical transmitter 14 (hereinafter “optical transmitter 14”), a well-known single optical fiber 16, a well-known multi-wavelength demultiplexed optical receiver 18 (hereinafter “optical receiver 18”) and a well-known DVI receiver 20.

The DVI transmitter 12 and multi-wavelength multiplexed optical transmitter 14 are included within a video generating device 11. The DVI transmitter 12 is comprised of a plurality of encoder/serializer circuits 22a, 22b and 22c which each receive digital video signals from the digital video generating device. Such a device might comprise, for example, an avionic video generator which is generating video signals for use on a cockpit display of an aircraft. It will be appreciated immediately, however, that the system 10 is not limited to use on aircraft. The system 10 may be used in any application where digital video signals need to be transmitted over distances greater than that allowed by a conventional DVI system employing copper conductors between the DVI transmitter and DVI receiver. Accordingly, the present invention will likely find utility in a variety of aerospace and aeronautical applications, and likely with mobile platforms such as ships, buses, submarines or any other form of mobile platform. It is also likely that the system 10 may be used in land based applications where a video generator needs to be located at some distance from its associated video display.

With further reference to FIG. 1, encoder/serializer 22a receives a data signal on inputs 24, a horizontal sync signal (HSYNC) on input 26 and a vertical sync (VSYNC) signal on input 28. Common input 30 data enable (DE) is used for enabling or disabling all the encoder/serializers 22a-c. Similarly, encoder/serializer 22b receives a data signal on inputs 32, and control signals on inputs 34 and 36. Encoder/serializer 22c receives a digital video data signal on input 40 while inputs 42 and 44 each receive control signals. The signals received by inputs 24, 32 and 40 represent byte-wide blue, green and red data signals.

The output of the DVI transmitter 12 represents encoded digital video signals and a clock signal (CLK) that are applied to drivers 48a-48d of the optical transmitter 14. In one preferred form, optical transmitter 14 comprises a coarse wavelength division multiplexing (CWDM) circuit. The outputs of each of the drivers 48a-48d are applied to a plurality of laser transmitters 50a-50d that produce a corresponding plurality of optical signals having different wavelengths. In one preferred form, the lasers 50a-50d comprise vertical cavity surface emitting lasers (VCSEL). In another preferred form, the lasers 50a-50d may comprise edge-emitting lasers, the choice being dictated by wavelength and cost. These optical signals having different wavelengths are output to a multiplexer 52 which transmits the four optical signals having different wavelengths simultaneously over the optical fiber 16.

The encoded optical signals traveling over optical fiber 16 are input to a demultiplexer 54 of the optical receiver 18, which in turn is part of a video display device 21. Receiver 18 also preferably comprises an array of optical receivers 56a-56d, one for each wavelength. The optical signals are demultiplexed back into a parallel plurality of video encoded optical signals and applied to optical receivers 56a-56d. The optical receivers 56a-56d convert the video encoded optical signals back into a corresponding plurality of video encoded electrical signals. The output of the optical receiver 18 is then applied to inputs 58a, 60a and 62a of a plurality of recovery/decoder circuits 58, 60 and 62, respectively. The recovery/decoder circuits 58, 60 and 62 serve to decode the video encoded electrical signals and output these signals to an inter-channel alignment circuit 64. The inter-channel alignment circuit 64 operates to time-align the digital video signal channels and to output aligned digital video signals to a conventional DVI connector, which in turn can be used to couple the signals to the input of a compatible video display device.

The encoded optical video signals transmitted over the optical fiber 16 may be transmitted at very high speeds, typically above 1 Gbps. The operation of multiplexing the optical signals and transmitting them over a single optical fiber 16 allows digital video signals to be transmitted over greater distances than would otherwise be possible with a conventional DVI interface system. Importantly, the system 10 of the present invention lends itself very well to applications involving aircraft and other mobile platforms where an avionics bay is typically located a considerable distance from a display unit. It further benefits from the use of commercial-off-the-shelf (COTS) components (i.e., DVI interfaces and CWDM transceivers) to be employed, which helps considerably to reduce costs.

While the system 10 has been described in connection with the use of a single optical fiber to convey four DVI interface signals, it will be appreciated that it could readily be adapted for use with the seven or more signals required of an upgraded DVI interface.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A digital video interface for enabling transmission of high speed video over extended distances between first and second video components, said interface comprising:
a digital video interface (DVI) transmitter for encoding video input signals from said first video component to produce a plurality of encoded video signals;
a multi-wavelength multiplexed optical transmitter responsive to said encoded video signals for generating a wavelength multiplexed set of video encoded optical signals encoded with video data;
an optical fiber for receiving and transmitting said multiplexed video encoded optical signals;
a multi-wavelength demultiplexed optical receiver for receiving said multiplexed video encoded optical signals from said optical fiber and demultiplexing said multiplexed video encoded optical signals to a plurality of demultiplexed video encoded optical signals therefrom, which are subsequently converted to video encoded electrical signals; and
a DVI receiver for receiving said video encoded electrical signals and generating therefrom a plurality of decoded digital video signals for output to said second video component.

2. The interface of claim 1, wherein said plurality of demultiplexed encoded video signals comprises a parallel plurality of video encoded electrical signals.

3. The interface of claim 1, wherein said video encoded optical signals are comprised of a plurality of different wavelength optical signals.

4. The interface of claim 1, wherein said video encoded optical signals comprise a plurality of parallel transmitted optical signals.

5. The interface of claim 1, wherein said plurality of decoded digital video signals comprises a plurality of parallel transmitted decoded video signals.

6. The interface of claim 1, wherein one of said video input signals comprises a clock signal.

7. The interface of claim 1, wherein said multi-wavelength multiplexed optical transmitter comprises a coarse wavelength division multiplexed optical transmitter element.

8. The interface of claim 1, wherein said multi-wavelength demultiplexed optical receiver comprises a coarse wavelength division multiplexed optical receiver element.

9. A digital video interface system (DVI) for enabling transmission of high-speed video over extended distances between first and second video components, said interface comprising:
a digital video interface (DVI) transmitter for encoding video input signals from said first video component into a plurality of video encoded, parallel transmitted signals;
a coarse wavelength division multiplexed optical transmitter for converting said video encoded, parallel transmitted signals to a multiplexed, video encoded optical signal comprised of a corresponding plurality of optical signals having different wavelengths;
an optical fiber for transmitting said multiplexed, video encoded optical signals thereover;
a coarse wavelength division demultiplexer for receiving said multiplexed, video encoded optical signals and generating therefrom a demultiplexed plurality of parallel, video encoded optical signals; and
a DVI receiver circuit for receiving said demultiplexed plurality of parallel, video encoded optical signals and generating therefrom a plurality of decoded video signals for driving said second video component.

10. The interface system of claim 9, wherein said video encoded, parallel transmitted signals comprise independent blue, green and red encoded video signals.

11. The interface system of claim 10, wherein said video encoded, parallel transmitted signals further comprise a clock signal.

12. The interface of claim 9, further comprising an inter-channel alignment subsystem for time-aligning said plurality of decoded video signals prior to transmitting said decoded video signals to said second video component.

13. A method for transmitting high speed digital video signals from at least one video generating component to a video display device over an extended distance beyond a distance limit of a standard digital video interface (DVI) system, the method comprising:
using a DVI transmitter to receive a plurality of video input signals from said at least one video generating component and to generate video encoded electrical signals;
using a plurality of optical transmitters at several wavelengths to convert the video encoded electrical signals to video encoded optical signals;
using an optical wavelength multiplexer to receive said video encoded optical signals and to generate therefrom a combined optical signal comprised of said video encoded optical signals each having different wavelengths and able to travel together on a single optical fiber;
using a single optical fiber to transmit said combined optical signal;
using a demultiplexer to receive said combined optical signal from said optical fiber and to demultiplex said combined optical signal to produce a parallel plurality of demultiplexed video encoded optical signals;
using a plurality of optical receivers to convert the demultiplexed video encoded optical signals to a parallel plurality of demultiplexed video encoded electrical signals; and
using a DVI receiver to receive and decode said parallel plurality of demultiplexed video encoded electrical signals for subsequent use in driving said video display device.

14. The method of claim 13, wherein said step of using a multi-wavelength multiplexed optical transmitter comprises using a coarse wavelength division multiplexed (CWDM) optical transmitter element.

15. The method of claim 13, wherein said step of using a demultiplexed optical receiver comprises using a coarse wavelength division multiplexed (CWDM) optical receiver element.

16. The method of claim 13, wherein the step of using said DVI transmitter comprises generating encoded digital red, green and blue video signals.

17. The method of claim 16, wherein the step of using said DVI transmitter to generate said video encoded electrical signals comprises generating an encoded clock signal.
